(19) United States
(12) Patent Application Publication
(10) Pub. No.: US 2011/0194238 A1
(43) Pub. Date: Aug. 11, 2011

(54) TERMINAL AND OPENING MECHANISM TO DISPLAY A MANIPULATION AREA OF A TERMINAL

(75) Inventor: Chang Jin SONG, Seoul (KR)

(73) Assignee: PANTECH CO., LTD., Seoul (KR)

(21) Appl. No.: 13/010,115

(22) Filed: Jan. 20, 2011

(30) Foreign Application Priority Data
Feb. 11, 2010 (KR) 10-2010-0012783

(51) Int. Cl. G06F 1/16

(52) U.S. Cl. 361/679.08; 361/679.02

(57) ABSTRACT

A terminal to display a usable manipulation area includes a first body unit, a second body unit, and an operation unit to slide the second body at an incline relative to the first body between a first position where the second body faces the first body, and a second position where the first body is exposed. The front surface of the second body may remain exposed when moving from a first position to the second position.

### CROSS-REFERENCE TO RELATED APPLICATION

This application claims priority from and the benefit of Korean Patent Application No. 10-2010-0012783, filed on Feb. 11, 2010, which is hereby incorporated by reference for all purposes as if fully set forth herein.

### BACKGROUND

1. Field

The following description relates to a terminal, and more particularly, to a terminal that may display a usable area of a body where manipulation keys may be provided.

2. Discussion of the Background

A conventional mobile terminal by which a user transmits and receives signals with another party may be a cellular phone, a personal communication service (PCS) phone, a personal digital assistant (PDA), and the like. Conventional mobile terminals may be classified as a bar-type, a flip type, a folder type, a slide type, and the like, and may be selected based on convenience and portability desired by the user. These various types of mobile communication terminals may be classified based on a display panel where information may be displayed and input keys where the information may be inputted.

Also, in a conventional slide type terminal, a sliding direction of the terminal is created in such a manner that the upper body slides parallel to the lower body. Specifically, the upper body and the lower body slide along a plane while keeping a distance spaced between the upper body and the lower body. Accordingly, an inconvenience may occur where the user should manipulate the upper body to align information displayed through the slid upper body with a viewing angle of the user, or in that the user should slouch to face the terminal.

Also, in a case multimedia services such as moving pictures and the like are provided using the terminal, it may be cumbersome and inconvenient for a user to use a separate holding stand for the terminal to adjust the viewing angle of the user in order to view the multimedia services for an extended period of time.

### SUMMARY

Exemplary embodiments of the present invention provide a terminal and opening mechanism to display the usable manipulation area of the terminal.

Additional features of the invention will be set forth in the description which follows, and in part will be apparent from the description, or may be learned by practice of the invention.

Exemplary embodiments of the present invention provide a terminal, including a first body wherein manipulation keys are provided on the first body, a second body unit wherein display panel is provided on the second body, and an operation unit to slide the second body at an incline relative to the first body between a first position where the second body faces the first body, and a second position where the first body is exposed, wherein the operation unit connects the first body with the second body and slides the second body in a first direction while connected the first body and the second body are rotated.

Exemplary embodiments of the present invention provide a terminal, including a first body unit, a second body unit facing the first body, and an operation unit to slide the second body at an incline relative to the first body wherein a front surface of the second body remains exposed between a first position where the second body faces the first body, and a second position where the first body is exposed, wherein the operation unit includes a connection unit connecting the second body to the first body so that the second body is rotated relative to the first body, and an operator to change position of the connection unit connected to the first body in a first direction.

Exemplary embodiments of the present invention provide a terminal, including a first body wherein manipulation keys are provided on the first body, a second body facing the first body unit wherein a display panel is provided on the second body, and an operation unit connecting the first body with the second body to slide the second body at an incline relative to the first body, wherein a front surface of the second body remains exposed between a first position where the second body faces the first body, and a second position where the first body is exposed, wherein the operation unit comprises a connection unit connecting the second body to the first body so that the second body is rotated relative to the first body as it moves between the first position and the second position, and an operator to change position of the connection unit connected to the first body as it moves between the first position and the second position.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view illustrating a terminal according to an exemplary embodiment of the invention;

FIG. 2 is a perspective view of the assembled terminal according to an exemplary embodiment of the invention;

FIG. 3 is a schematic perspective view illustrating a terminal positioned in a second position according to an exemplary embodiment of the invention;

FIG. 4 is a perspective view schematically illustrating an assembled operation unit according to an exemplary embodiment of the invention;

FIG. 5 is a schematic cross-sectional view illustrating a terminal positioned in a first position according to an exemplary embodiment of the invention;

FIG. 6, FIG. 7 and FIG. 8 are schematic cross-sectional views illustrating a second body moving in a sliding manner from the first position to a second position by an operator while being rotated according to an exemplary embodiment of the invention; and

FIG. 9 is a schematic cross-sectional view illustrating a terminal positioned in a second position according to an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that when an element is referred to as being “on” or “connected to” or “coupled to” another element, it can be directly on, directly connected to, or directly coupled to the other element, or intervening elements may be present. In contrast, if an element is referred to as being “directly on” or “directly connected to” or “directly coupled to” another element, no intervening elements are present. Throughout the drawings and the detailed description, unless otherwise described, the same drawing reference numerals are understood to refer to the same elements, features, and structures. The relative size and depiction of these elements may be exaggerated for clarity, illustration, and convenience.

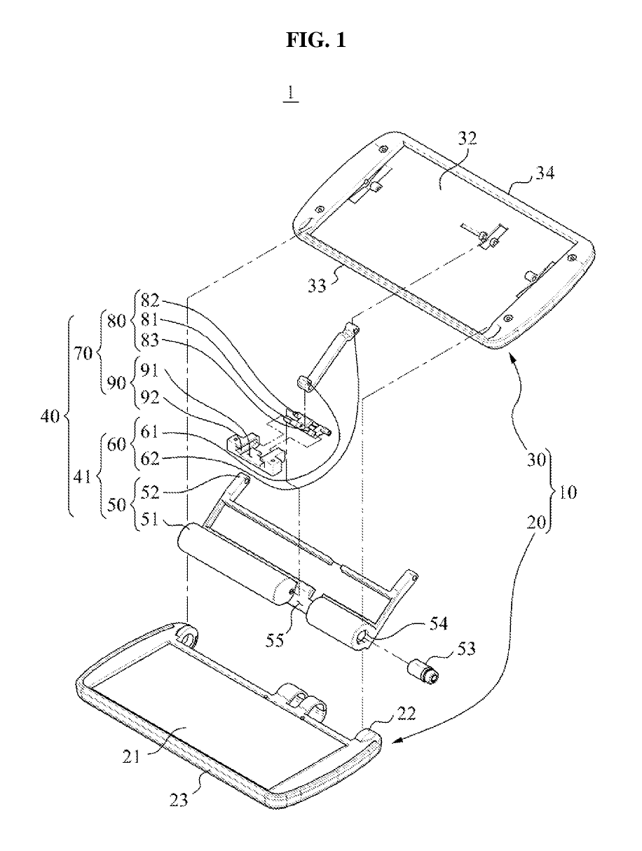

FIG. 1 is an exploded perspective view illustrating a terminal according to an exemplary embodiment of the invention.

In an example, a terminal 1 illustrated in FIG. 1 according to an embodiment may be a handheld terminal provided for a mobile communication, such as a cellular phone, a personal digital assistant (PDA) phone, a digital multimedia broadcasting (DMB) phone, and the like. However, the present invention is not limited thereto. Terminal 1 may be a terminal of various electronic equipments which includes an input unit and a display unit, such as an electronic dictionary, etc.

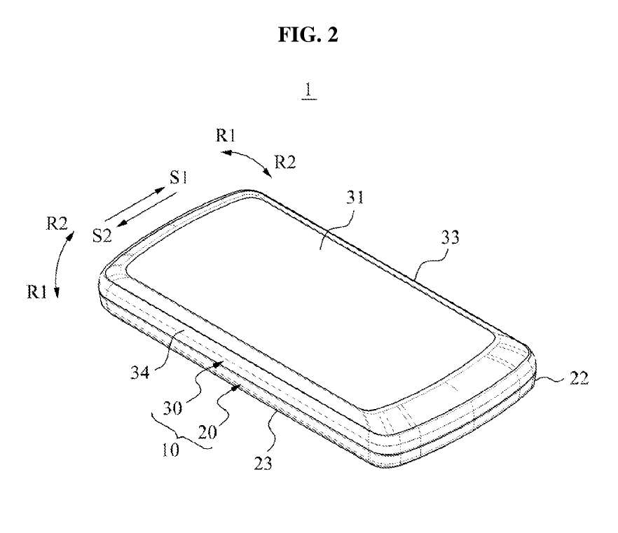

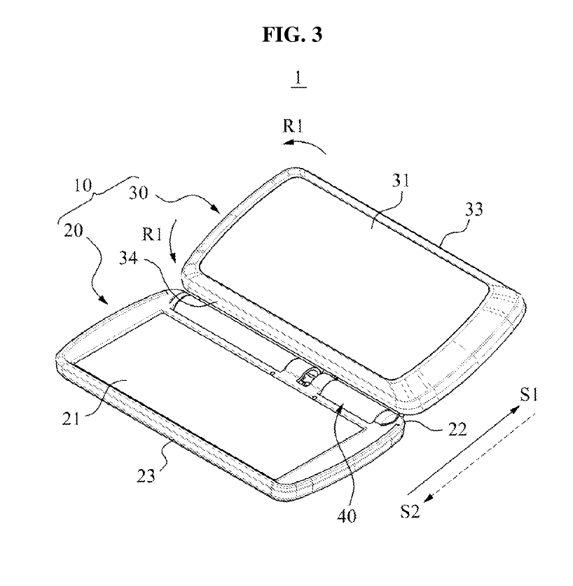

As shown in FIG. 1, terminal 1 includes a body unit 10 (shown in FIG. 2 and FIG. 3) and an operation unit 40. A body unit 10 includes a first body 20 and a second body 30 facing the first body 20. Here, the first body 20 and the second body 30 may have various functions for terminal 1. First body includes a front surface 21, a front end 22, and a front edge 23. Second body includes a front surface 31(shown in FIG. 2), a rear surface 32, a front end 33, and a rear end 34. Operation unit 40 may include a connection unit 41, and an operator 70. The connection unit 41 of operation unit 40 includes a first connection member 50, and a second connection member 60.

The first connection member 50 includes a first hinge end 51, a second hinge end 52, a click hinge 53, a click groove 54, and an installation groove. The second connection member 60 includes a first connection end 61, and a second connection end 62. The operator 70 may include a first operation member 80 and a second operation member 90. The first operation member 80 includes a first operation end 81, a second operation end 82, and a rail protrusion 83. Lastly, the second operation member 90 includes an operation rail 91, and a rail groove 92.

FIG. 2 is a perspective view of the assembled terminal of according to an exemplary embodiment of the invention. As shown in FIG. 2, the second body 30 is arranged on top of the first body 20, exposing the front surface 31 to define a first position. Further, rear surface 32 (not shown) is directly facing front surface 21 (not shown) of the first body 20. The second body 30 may be pushed in a sliding direction S1 from the first position to a second position by pushing on the rear end 34 of the second body. In an example, the sliding direction S1 moves towards the front end 33, in a direction parallel to the shorter ends of the terminal as illustrated in FIG. 2. However, direction of S1 is not limited to the illustration provided in FIG. 2 and may be directed in various ways.

Further, when the second body 30 is pushed in the sliding direction S1, the second body 30 will also rotate in the direction of R2. Likewise, if the second body 30 is pushed in a sliding direction S2 from the second position (not shown) towards the first position, the second body 30 will rotate in the direction of R1. However, the rotating direction is not limited to the illustration provided in FIG. 2 and may be rotated in various directions.

As an example, the first body 20 and the second body 30 may be formed into a rectangular-like shape, in comparatively similar sizes. However, the shapes of the first body 20 and the second body 30 illustrated in FIG. 2 are merely an example, and the present invention is not limited thereto.

FIG. 3 is a schematic perspective view illustrating a terminal positioned in a second position according to an exemplary embodiment of the invention.

As shown in FIG. 3, the mobile terminal 10 is in a second position where the front surface 21 of first body 20 is exposed and front surface 31 of second body 30 is also exposed, and may face the user. Second position may be provided by having pushed the second body 30 in the S1 direction by pushing on the rear end 34 of the second body. Likewise, second body 30 may be pushed in the S2 direction to move back towards a first position. In sliding back towards the first position, the second body will rotate in a R1 direction so that front surface 31 remains exposed during movement. Accordingly, the front surface 31 of the second body 30 may remain exposed regardless of a position of the second body 30, and a rear surface 32 may face the front surface 21 in the first position.

Further, an operation unit 40 may be interposed between the first body 20 and the second body 30 so that the second body 30 slides at an incline relative to the first body 20, allowing movement from the first position to the second position and vice versa. Specifically, the operation unit 40 may enable the second body 30 to slide at an incline relative to the first body 20 between a first position where the second body 30 faces the first body 20 as illustrated in FIG. 2, and a second position where the front surface 21 of the first body 20 is exposed as illustrated in FIG. 3. In the second position, the front surface 21 of the first body 20 may be completely exposed. Also, the front surface 31 of the second body 30 may be always exposed regardless of a position of the second body 30, and a rear surface 32 of the second body 30 may face the front surface 21 of the first body 20 only in the first position.

In an example, a display panel is provided on a front surface 31 of the second body 30, and manipulation keys are provided on a front surface 21 of the first body 20. Accordingly, the display panel provided on the second body 30 may include touch input-manipulation keys that are selectively implemented by a touch input scheme, and the manipulation keys provided on the first body 20 may be selectively implemented by the touch input scheme.

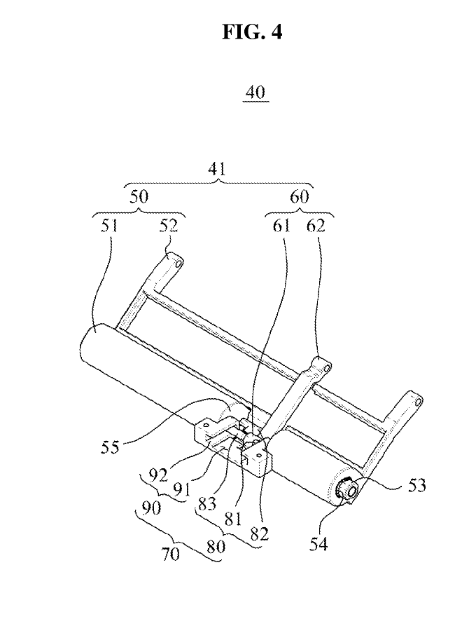

FIG. 4 is a perspective view schematically illustrating an assembled operation unit according to an exemplary embodiment of the invention. As shown in FIG. 1 and FIG. 4, to provide for a sliding movement of the second body 30 between the first position and the second position, the operation unit 40 includes a first connection member 50, a second connection member 60, and an operator 70.

The first connection member 50 may connect the first body 20 and the second body 30 in such a manner that the second body 30 may be moved in a rotating manner relative to the first body 20. As an example, a single first connection member 50 may be mounted between the first body 20 and the second body 30. However, a number of the first connection members 50 may not be limited thereto.

The first connection member 50 includes a first hinge end 51 connected by a hinge (hinge-connected) to the first body 20, and a second hinge end 52 hinge-connected to the second body 30. In an example, the first hinge end 51 may be hinge-connected to a front end 22 of the first body 20 towards the second position from the first position with respect to sliding directions S1 and S2 of the second body 30. Also, the second hinge end 52 may be hinge-connected to the rear surface 32 facing the first body 20. The second hinge end 52 may be connected to the rear surface 32 close to a rear end 34 when sliding in the direction of S1 (from the first position to the second position), so that a rotation range of the second body 30 relative to the first body 20 may be increased. Due to the increase in the rotation range of the second body 30, the first body 20 may be exposed in the second position.

The first hinge end 51 of the first connection member 50 may include a click groove 54 to enable a click hinge 53 coupled to the front end 22 to be inserted into the click groove 54. In an example, the click hinge 53 may restrict the rotation range of the second body 30 with respect to the first hinge end 51.

The second connection member 60 includes, a first connection end 61 connected to the first body 20 and a second connection end 62 connected to the second body 30. In an example, the first connection end 61 may be selectively operated in a direction where the second body 30 slides, together with a sliding movement of the second body 30. Specifically, the first connection end 61 may slide in the sliding directions S1 and S2 while being connected to the first body 20. Preferably, the first connection end 61 may be mounted eccentrically with respect to the second connection member 60, thereby providing a semi-automatic operational force when the second connection member 60 is rotated by a predetermined radius, such as in a case of a cam.

The second connection end 62 may be hinge-connected to the rear surface 32. The second connection end 62 may be mounted closer to the rear surface 32 than to the second hinge end 52. This may allow the rear surface 32 to be intercepted by the second connection member 60 to be pressurized towards the first body 20 if the second body 30 is rotated with respect to the first hinge end 51. This step may occur while the second body 30 is moved between the first position and the second position. Accordingly, the front surface 31 may remain exposed while preventing the front surface 31 and the rear surface 32 from being mutually inverted while second body 30 is being rotated between the first position and the second position.

The first connection member 50 and the second connection member 60 may function to connect the first body 20 and the second body 30 to each other, and thus a shape and a number of the first and second connection members 50 and 60 may not be limited to the illustrated example.

The operator 70 may operate the first connection end 61 in the sliding directions S1 and S2. For this, the operator 70 may include a first operation member 80 and a second operation member 90.

The first operation member 80 may include a first operation end 81 connected to the first connection end 61, and a second operation end 82 hinge-connected to the first hinge end 51. In an example, the second operation end 82 may be inserted into and mounted on an installation groove 55 formed, in a stepped manner, on the first hinge end 51.

The second operation member 90 may include an operation rail 91 arranged parallel to the sliding directions S1 and S2 to enable the first operation end 81 to be inserted into the operation rail 91. The second operation member 90 may be mounted on the first body 20. More specifically, the operation rail 91 having a width corresponding to a width of the first operation member 80 may be arranged, in a stepped manner, on an upper surface of the second operation member 90. In an example, a rail groove 92 may be arranged on both sides of the operation rail 91, so that a rail protrusion 83 may be inserted into the rail groove 92. Rail protrusion 83 is arranged in a protrusive manner from both sides of the first operation end 81 to fit rail groove 92. Accordingly, the first operation end 81 is inserted into the operation rail 91 preventing the first operation end 81 from being separated from the operation rail 91, which allows second body 30 to be moved in the sliding directions S1 and S2 along the operation rail 91.

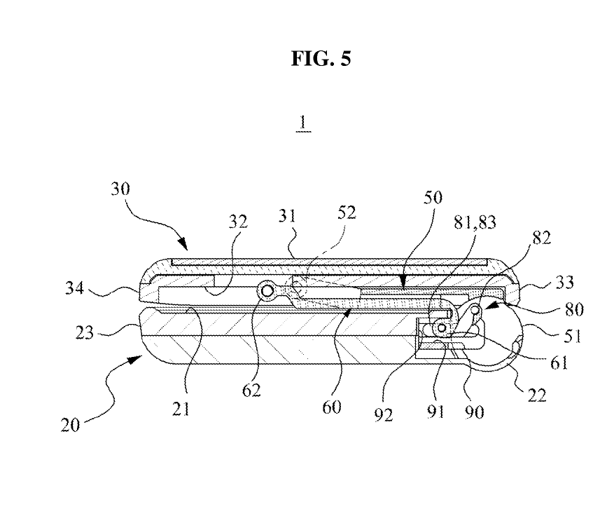

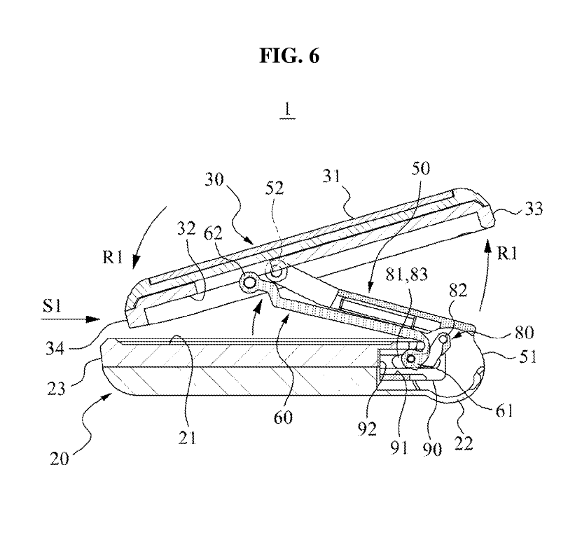

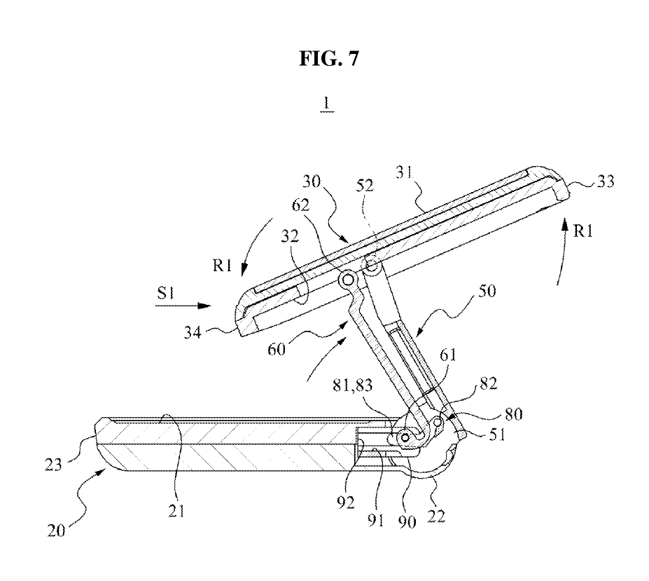

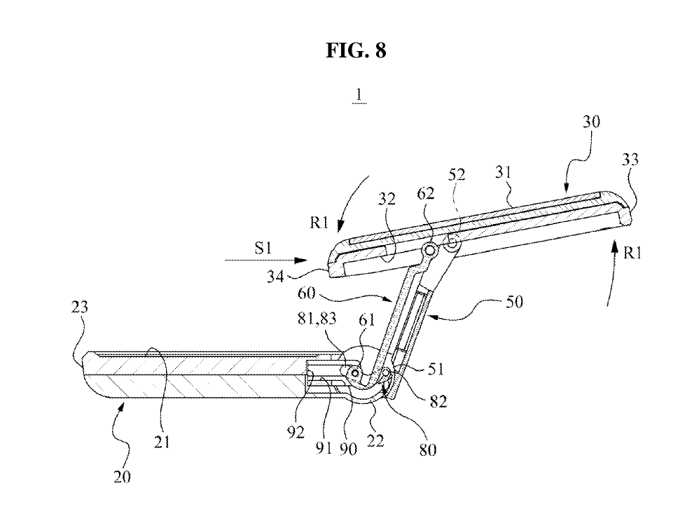

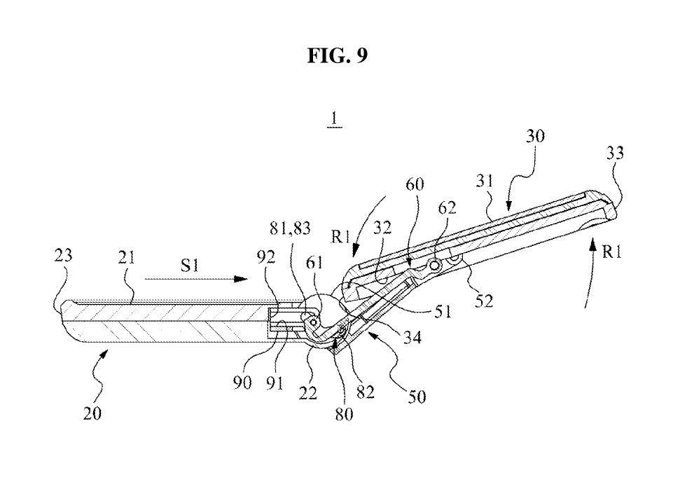

A sliding operation of the terminal 1 having the above described configuration will be described in detail with reference to FIG. 5, FIG. 6, FIG. 7, FIG. 8, and FIG. 9.

FIG. 5 is a schematic cross-sectional view illustrating a terminal positioned in a first position according to an exemplary embodiment of the invention.

As shown in FIG. 5, the first body 20 and the second body 30 are positioned in the first position where the front surface 21 and the rear surface 32 face each other. In this case, the second hinge end 52 faces the front surface 21, and the second connection end 62 faces the front surface 21. Also, the rail protrusion 83 connected to the first connection end 61 may be positioned in the left side of the rail groove 92 as shown in FIG. 5.

FIG. 6, FIG. 7, and FIG. 8 are schematic cross-sectional views illustrating a second body moving in a sliding manner from the first position to a second position by an operator while being rotated according to an exemplary embodiment of the invention

Subsequently, as shown in FIG. 6, when the rear end 32 slides in the direction of S1, a front end 33 is rotated in a R1 direction with respect to the second hinge end 52 by a sliding force of the second body 30. Thus, the second body 30 may be spaced apart from the first body 20. This rotation operation of the second body 30 may be performed such that the second body 30 is pressurized in the sliding direction of S1, and the first connection member 50 connected to the second body 30 is rotated in the R1 direction as shown in FIG. 6 by means of a force of restitution.

In addition, together with the sliding movement of the second body 30, the second connection member 60 connected to the second body 30 may be moved in a sliding manner in the direction of S1. In this instance, together with the movement of the second connection member 60 in the sliding direction S1, the rail protrusion 83 protruding from the first operation end 81 may be gradually moved in the sliding direction S1 along the rail groove 92.

As shown in FIG. 7, when the second body 30 continues to be moved in the sliding direction S1, the first connection member 50 connected to the second body 30 may be rotated in a R1 direction, so that the second hinge end 52 may be spaced apart from the first body 20. Together with a rotation of the hinge end 52, the second body 30 may be lifted up from the first body 20. In addition, together with the movement of the second body 30, the rail protrusion 83 connected to the first connection end 61 may continue to be moved in the sliding direction S1 along the rail groove 92. In an example, the rear end 34 may be rotated while facing the first body 20 due to the connection between the second body 30 and the second connection member 60.

Subsequently, as shown in FIG. 8, when the second body 20 continues to be moved in the sliding direction S1, the first connection member 50 may be rotated to be spaced apart from the first body 20, and the second body 30 may be rotated until reaching the second position where the second body 30 is completely deviated from the first body 20 as shown in FIG. 9. In an example, a rotation range of the second body 30 may be determined by the click hinge 53 connected to the front end 22, and the rotation radius of the second connection member 60 may be obtained with respect to the first connection end 61.

As shown in FIG. 9, the second body 30 is connected to the first body 20 by the first connection member 50 and the second connection member 60. The rear end 34 may be brought in close contact with the front end 22 by a rotation force R1 of the second connection member 60. As a result, the front surface 31 may be moved from a first position to a second position while being exposed.

In addition, as shown in FIG. 9, the front and rear ends 34 and 35 are rotated in the R1 direction with respect to the second connection end 62 even after the second body 30 is completely deviated from the first body 20. This allows the first connection end 61 to be continually moved in the sliding direction S1 along the rail groove 92 by a connection between the first connection end 61 and the first operation member 80. In this manner, a position of the first connection end 61 may be changed from a left side to a right side along the rail groove 92, together with the movement of the second body 30 from the first position to the second position. Accordingly, a connection position of the second operation member 90 relative to the first body 20 may vary.

The operation of the terminal 1 where the second body 30 is moved from the first position to the second position was described. Similarly, the opposite processes as described with reference to FIG. 5, FIG. 6, FIG. 7, FIG. 8, and FIG. 9 may be performed when desiring to move the second body 30, positioned in the second position, to the first position in the sliding direction S2. Thus, further descriptions thereof will be omitted.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a first body comprising manipulation keys;
a second body comprising a display panel; and
an operation unit to slide the second body at an incline relative to the first body between a first position where the second body faces the first body, and a second position where the first body is exposed,
wherein the operation unit connects the first body with the second body, and slides the second body in a first direction while the first body and the second body are rotated.

2. The terminal of claim 1, wherein the operation unit comprises:
an operator to change a position of the connection unit connected to the first body in a first direction;
a first connection member to connect the first body and the second body to be rotated; and
a second connection member to restrict the rotation range of the second body.

3. The terminal of claim 2, wherein the first connection member comprises:
a first hinge end connected to an end of the first body; and
a second hinge end connected to a rear surface of the second body.

4. The terminal of claim 2, wherein the second connection member comprises:
a first connection end connected to the first body to slide together with the movement of the second body; and
a second connection end connected to the second body to allow the rear surface of the second body to be intercepted by the second connection member to be pressurized towards the first body if the second body is rotated with respect to the first hinge end.

5. The terminal of claim 4, wherein operator comprises:
a first operation member comprising a first operation end connected to the first connection end of the second connection member, and a second operation end connected to the first hinge end of the first connection member; and
a second operation member comprising an operation rail arranged parallel to the sliding direction and the first operation member to insert into the second operation member.

6. The terminal of claim 5, wherein the second operation member is mounted on the first body.

7. A terminal, comprising:
a first body;
a second body facing the first body; and
an operation unit to slide the second body at an incline relative to the first body,
wherein a front surface of the second body remains exposed between a first position where the second body faces the first body, and a second position where the first body is exposed, and
wherein the operation unit comprises:
a connection unit connecting the second body to the first body so that the second body is rotated relative to the first body; and
an operator to change position of the connection unit connected to the first body in a first direction.

8. The terminal of claim 7, wherein the connection unit comprises:
a first connection member comprising a first hinge end connected to an end of the first body where the first hinge end rotates as it moves towards the second position from the first position; and
a second connection member comprising a second hinge end being connected to the rear surface of the second body, where the second hinge rotates as it moves in a sliding direction from the first position to the second position.

9. The terminal of claim 8, wherein the second connection member comprises:
a first connection end to be operated in a sliding direction of the second body, together with a sliding movement of the second body; and
a second connection end to connect to the second body to allow the rear surface of the second body to be intercepted by the second connection member to be pressurized towards the first body if the second body is rotated with respect to the first hinge end.

10. The terminal of claim 8, wherein the operator comprises:
a first operation member comprising, a first operation end connected to the first connection end of the second connection member, and a second operation end connected to the first hinge end of the first connection member; and
a second operation member comprising, an operation rail formed parallel to the sliding direction and the first operation member to insert into the second operation member.

11. The terminal in claim 8, wherein the second operation member is mounted on the first body.

12. A terminal, comprising:
a first body comprising manipulation keys;
a second body facing the first body unit and comprising a display panel; and
an operation unit connecting the first body with the second body to slide the second body at an incline relative to the first body, wherein a front surface of the second body remains exposed between a first position where the second body faces the first body, and a second position where the first body is exposed,
wherein the operation unit comprises:
a connection unit connecting the second body to the first body so that the second body is rotated relative to the first body as it moves between the first position and the second position; and
an operator to change position of the connection unit connected to the first body as it moves between the first position and the second position.
